(19) United States
(12) Patent Application Publication
(10) Pub. No.: US 2003/0093940 A1
(43) Pub. Date: May 22, 2003

(54) Rabbit hair fishing lure

(76) Inventors: Mark Stephen Walker, Edwards, CO (US); Daniel Charles Bryant, Avon, CO (US)

Correspondence Address: Henry L. Smith, Jr., 9273 S. Cornell Circle, Highlands Ranch, CO, 80130, US

(21) Appl. No.: 09/992,985

(22) Filed: Nov. 16, 2001

(51) Int. Cl. A01K 85/00

(52) U.S. Cl. 43/42.25

(57) ABSTRACT

A fishing lure comprising one or more pieces of rabbit hair, with or without attached rabbit skin, of size sufficient to noticeably move when saturated with water thereby attracting fish to the movement and causing them to bite the lure.

### BACKGROUND

1. Field of the Invention

The field of the invention is the field of fishing lures employed by fishermen to catch primarily one fish at a time by attaching the lure to the end of a fishing line. The invention also is in the category of lures which, in various ways, either imitate insects, crayfish, bait fish, etc. or other fish food, or by their constant and pronounced motion on the surface of the water or in the water, attract the attention of the fish and cause them to bite the lure and the hook or similar device contained therein.

2. Description of Prior Art

Various fishing lures have been used for years by fishermen and have incorporated many different features to either hide the hook, or in various ways to attract the attention of the fish through movement or through similarity to an food source which the fish likes to eat. The following patents are representative of the prior art. U.S. Pat. No. 1,884,053, Mar. 20, 1931, to R. McGarraugh, discloses a fishing lure containing a hook which is hidden within a bunch of hairs or feathers, the function of which is apparently to disguise the hook and to serve as a weedguard to prevent the hook from snagging underwater plants, etc. U.S. Pat. No. 1,994,692, Jul. 6, 1932, to S. F. Davenport discloses another lure in which a bundle of hairs is designed to imitate the wings of an insect. Another patent which mentions hair is U.S. Pat. No. 3,659,3 71, May 2, 1972, to W. O. Duescher, in which there is mention of animal hair as part of the lure; however, there is no mention of any special movement of the hair in the water. U.S. Pat. No. 4,841,667, Jun. 27, 1989, to R. R. Johns, does mention rabbit hair as a possible component material; however, again there is no discussion of a special motion of the hair in the water; only a small amount of rabbit hair is used. The prior art lures do not generally have enough inherent motion to imitate a food source, and attract the fish. Generally, prior art lures require motion of the air, water, or fishing line to cause the lure to exhibit its own motion, and thus attract the fish.

### SUMMARY OF INVENTION

The present invention uses real rabbit hair and skin from a rabbit, and uses the rabbit hair in a configuration adapted to cause the rabbit hair part of the lure to move, on or in the water, in a unique and very active, pulsating, buoyant motion, virtually independent of the motion of the fishing line, the air, or the water surrounding the lure. The rabbit hair comes alive in the water, and this unusual motion attracts the attention of the fish and causes the fish to aggressively strike on the lure. Thus the fish is caught by the hook contained within the lure, and the fish can be removed from the water by the fisherman. Rabbit hair, unlike any other material which the inventors are aware of, exhibits very pronounced and special motions on the surface of the water, or below the surface of the water, when incorporated into a lure. This constant pulsating motion is thought to be produced by the fact that the rabbit hair, in an apparently unique way, holds multiple small bubbles of air which makes it buoyant and likely to move in various ways as the air bubbles tend to move toward the surface of the water. The motion may also be produced by the special flexibility of the rabbit skin to which the hairs are attached, and perhaps due to motion imparted to the rabbit skin as it absorbs water and expands in different amounts and directions at different points of the rabbit skin surface. Rabbit hair is thinner, more flexible, and more buoyant than other animal fur. It also has a thinner hide, which contributes to its flexibility and motion in the water. The net effect is that even when he fishing line, air, and water are still, the rabbit hair is in frequent and pronounced motion because of the buoyancy of the trapped air bubbles and the flexing of the underlying rabbit skin. This motion strongly attracts the attention of the fish and produces a high probability that the fish will strike or bite the lure.

### Objects and Advantages

The objects of the present invention are:

1. By unusually constant motion of the lure, to attract the attention of the fish.

2. To cause the fish to bite the lure because of this motion.

3. To produce a lure which has buoyancy, and less tendency to become inert in the water.

4. To produce a lure which engages in significant motion virtually without motion of the fishing line or surrounding air or water.

5. To produce a lure which engages in significant motion for an extended time especially after becoming wet.

6. To produce a lure which engages in significant motion each time it is used, even after many uses.

7. To produce a lure which attracts the attention of the fish significantly more than other lures, and which causes the fish to strike more frequently and more aggressively, because it imitates in a more lifelike way the creatures the fish like to eat.

8. To produce a lure involving free-flowing motion, buoyancy, and pulsating action in the water due to the thin hair and flexible skin of the rabbit.

Still further objects and advantages will become evident from the detailed description of the invention, and the drawings.

### DRAWING FIGURES

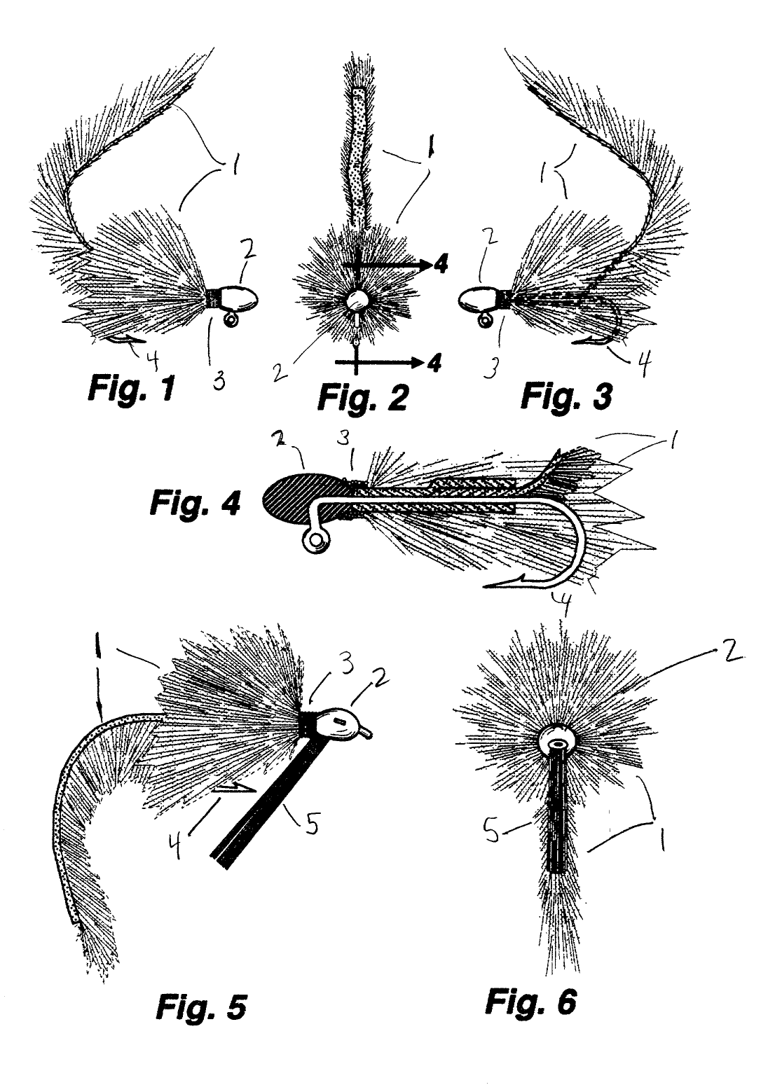

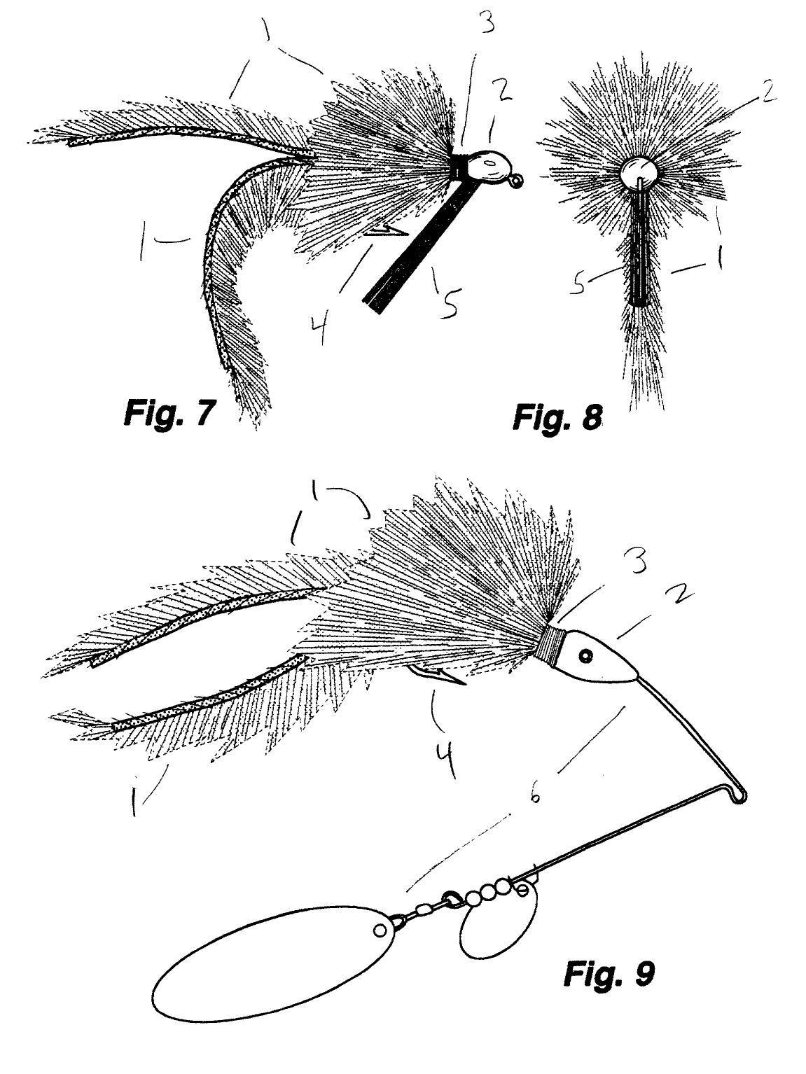

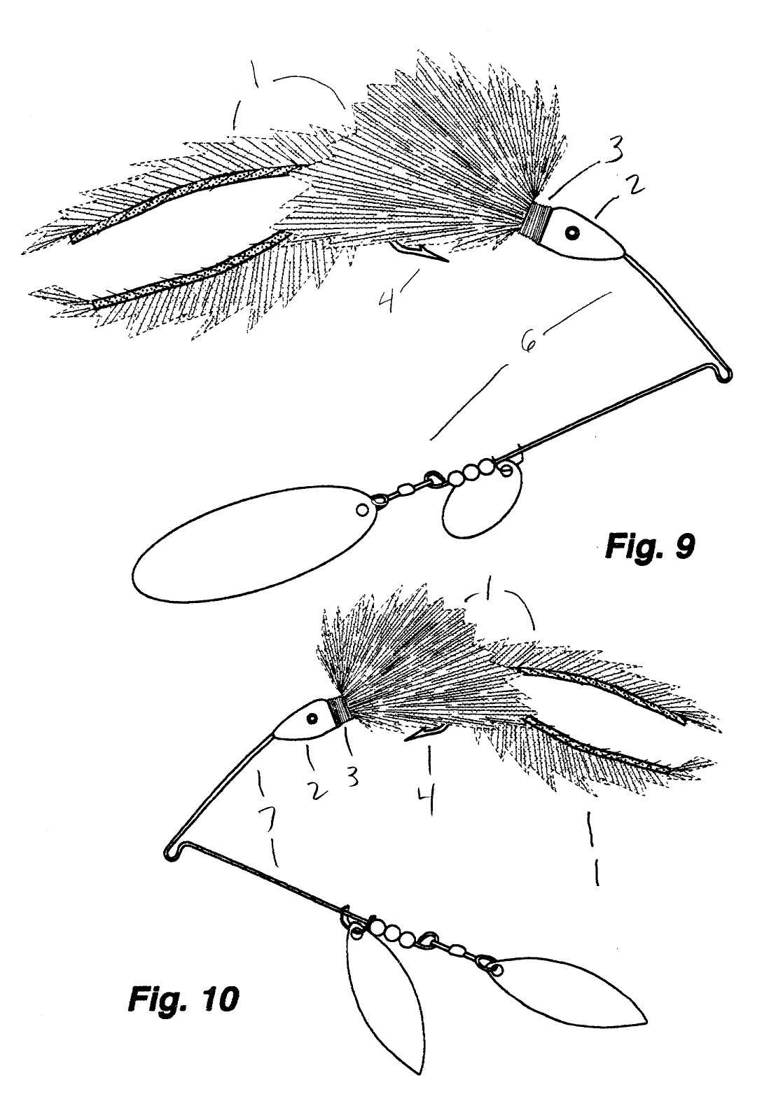

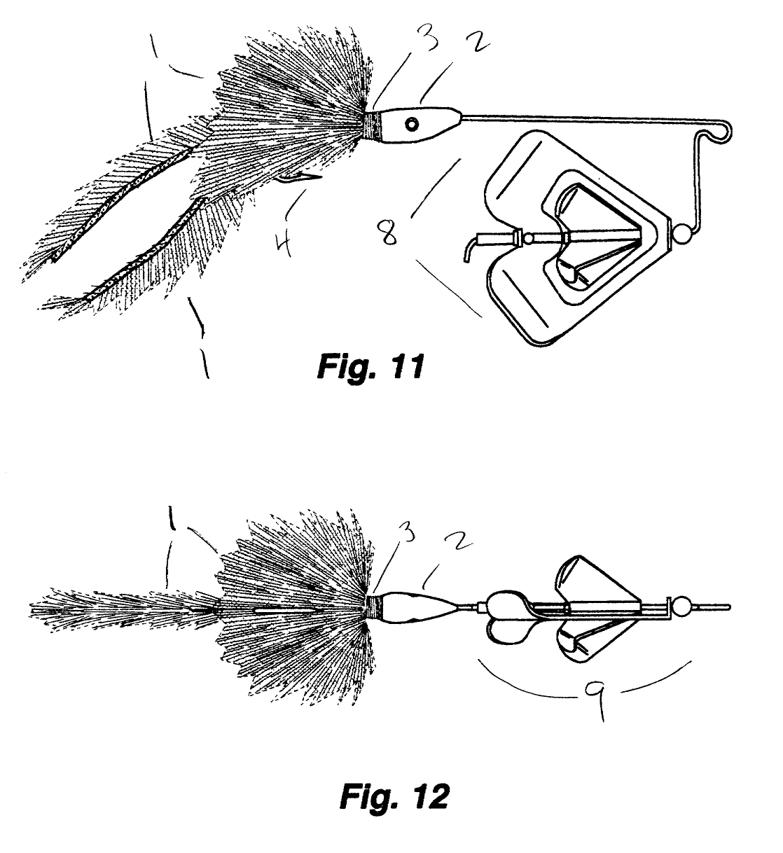

The figures are only some examples of how the hair may be used. FIG. 1 shows, in side view, the standard jig single tail version of the lure without a weedguard. FIG. 2 is an end view of the lure in FIG. 1. FIG. 3 is similar to FIG. 1 but shows the structure of the hook 4 attached to the head 2 underneath the rabbit hair 1. FIG. 4 is a close-up view similar to FIG. 1 and FIG. 3 showing the head 2, the hook 4, and the tying thread 3 used to attach rabbit hair 1 to the hook 4. FIG. 5 shows another version of the lure with black fiber weedguard 5; this is a small mouth jig single tail lure. FIG. 6 is a front view of the lure in FIG. 5. FIG. 7 is similar to FIG. 5 except that it represents a largemouth jig with two tails. FIG. 5 is a standard one tail lure. FIG. 8 is a front end view of FIG. 7. FIG. 9 represents a double tail spinner bait version of the lure with willow leaf and Colorado blade assembly. FIG. 10 represents the double willow leaf spinner bait version of the lure with double tails. FIG. 11 represents the power buzz bait double blade version of the lure with double tails. FIG. 12 is a top view of FIG. 11 with a different kind of double blade assembly.

### REFERENCE NUMERALS IN DRAWINGS

1 rabbit hair

2 head

3 tying thread

4 hook

5 black fiber weedguard

6 willow leaf and Colorado blade assembly

7 double willow leaf spinner bait assembly

8 power buzz bait assembly

9 double blade power buzz bait assembly

### DETAILED DESCRIPTION OF THE DRAWINGS

FIG. 1 shows, in side view, the standard jig single tail version of the lure without a weedguard. Two portions of rabbit hair 1 are shown attached to lure, the elongated tailpiece and another headpiece attached to the head 2 by tying thread 3. The hook 4 is partially hidden by the piece of rabbit hair. FIG. 2 is a head-on view of the lure in FIG. 1, showing the elongated portion of the rabbit hair 1 and headpiece portion of the rabbit hair. Also shown is head 2. FIG. 3 is another side view of the lure shown in FIG. 1, with added detail about the structure of the hook 4 and the attachment of the elongated piece of rabbit hair 1. FIG. 4 is a close-up view of the lure in FIG. 1 with the whole hook 4, the tying thread 3, and the elongated and wide piece of rabbit hair 1. FIG. 4 shows a lure with a weedguard 5, comprised of pieces of black fiber. FIG. 6 is the front view of the lure in FIG. 5 showing the two portions of rabbit hair 1, head 2, and the black fiber weedguard 5. FIG. 7 represents a largemouth jig double tail lure, with black fiber weedguard 5. Also shown are three portions of rabbit hair 1, namely, a double tail and a portion of rabbit hair near the head 2. Also shown are tying thread 3, head 2, and hook 4. FIG. 8 is a head-on view of the lure shown in FIG. 7, showing the portions of rabbit hair 1, black fiber weedguard 5, and head 2.

FIG. 9 represents a double tail spinner bait version of the lure with willow leaf and Colorado blade assembly. The latter assembly is not claimed as part of the invention. The figure shows three portions of rabbit hair I (a double tail and a wide headpiece), hook 4, tying thread 3, and head 2. FIG. 10 represents the double willow leaf spinner bait version of the lure. The double willow leaf spinner bait assembly 7 is not claimed as part of the invention. The figure shows three portions of rabbit hair 1 (two tails and a headpiece), hook 4, tying thread 3, and head 2.

FIG. 11 represents the power buzz bait double blade version of the lure. The power buzz bait assembly 8 is not claimed as part of the invention. The Figure shows three portions of rabbit hair 1—two tail portions and a headpiece. Also shown are hook 4, tying thread 3, and head 2. FIG. 12 is a top view of the lure in FIG. 11, showing the rabbit hair tail and headpiece, tying thread 3, head 2, and a double blade power buzz bait assembly 9. The assembly 9 is not claimed.

### Description—Preferred Embodiment

The preferred embodiment of the invention may have a number of forms. The essence of the preferred embodiment is one or more portions of genuine rabbit hair (still attached to the skin of the rabbit) and affixed to the lure so that the piece of rabbit skin (with the attached rabbit hair) can easily flex in the water when wet. The piece of rabbit hair must also be large enough so that it will attract and hold air bubbles after immersion in the water. The rabbit hair still attached to the skin is prepared in a standard taxidermy tanning process from cottontail rabbits or other species. Typically the tanned skin and hair are treated with solvents to remove the wax from the hair, and then cut into strips.

### Operation of the Invention

The operation of the invention is the unique motion of the rabbit hair (affixed to a piece of rabbit skin) in the water. This unique and very active motion is caused by the fact that the fibers of the rabbit hair attract and hold air bubbles especially after immersion in the water, or when floating on the surface of the water. The flexibility of the underlying rabbit skin results in constant and pulsating motion of the rabbit hair mostly independently of the motion of the air, water, or fishing line. The retention of the air bubbles may be due to natural oil on the rabbit hair or the hydrophobic nature of the rabbit hair. The Applicants are not aware of any other animal hair, or other hair, or artificial fibers, which exhibit this behavior in the water. Once it has been saturated with water for three to five minutes, the unique active motion of the rabbit hair in the water does not disappear over time, even after it is thoroughly saturated with water. This behavior strongly attracts the attention of the fish because the fish may think that the lure is a food source, or it may trigger the fish's curiosity, or aggression, or defense reaction.

### Tests

The following are testimonials and tests of the invention by prominent fishermen in the industry. Actual quantitative tests in totally controlled environments are very difficult to achieve in the fishing art. However, the experience and opinions of experts in the art are very persuasive, and inherently compare the performance of the present invention with other fishing lures.

“The first time that I saw the Hammerin' Hare rabbit hair lures I knew that I had never seen a lure action like the rabbit hair exhibits in the water. The rabbit hair in the water flows and seems to be almost alive. The look and feel of the lures themselves had a natural feel and texture unlike anything that I had seen in the past 20 years of my professional fishing career. The rabbit hair moves in the water with just the slightest current or action from the angler. The tail on the Hammerin' Hare jigs curls up in the water simulating the exact action of a crayfish. I have never seen this with any other lures before.”—Garry Mason, Professional Guide and Fishermen, Adventures Outdoors

“Having been a fisherman for the past 45 years or more I want to tell you of my experience with your Hammerin' Hare rabbit hair jigs, spinnerbaits and buzzbaits. The action that the rabbit hair provides is quite unique. In fact I have never seen a lure made with any other material with quite the same fish catching action as the Hammerin' Hare lures. The Hammerin' Hare lures have a certain tantalizing movement in the water that I have not seen before. The hair breathes and pulsates almost on its own. Air bubbles are released from the lures making them the most realistic looking lure I have ever seen. The rabbit hair skirts on the spinnerbaits open and close with a stop and go retrieve making them totally unlike any of the other spinnerbaits that use rubber and silicon skirts.”—Michael Pace, Bass Fishing USA

“After fishing for 35 years I'd thought I've seen every lure and material combination that could possibly be put together. After seeing and fishing with the Hammerin' Hare line of baits from the Strike On Lure Company out of Edwards, Colo., I was wrong and pleasantly surprised that American ingenuity still exists in the lure industry. The rabbit hair has a life of its own in the water that creates a totally new action that the fish have never seen before. The Hammerin' Hare Jigs seem to be alive and move with the slightest touch from the angler or water current. The other thing noticeable is the air that is released from the hair while the lure is being moved in the water. This makes for very lifelike lures simulating a minnow or crayfish that I have never seen in any other lure before. Fish pick these lures up off the bottom while sitting still. I have never seen this happen with any other lure I have fished. The built in double tail rabbit hair trailers found on all of the lures are a feature completely unique to these lures and are not found on any other freshwater lure of similar type in the industry.”—Tony Strickland, Florida Guide and Charter Service, Pres. Central Florida Bass Anglers, V.P. Teen Angler Program, Tournament Director Florida Disabled Anglers

“The Hammerin' Hare lure series made by Strike On! Lures are totally unique. The lure reaction in the water could not be duplicated by any other lures that I have seen. The lures come alive in water. The rabbit hair breathes and pulsates constantly creating a lifelike action that drives fish crazy. The hair apparently has the ability to capture air as I have seen small air bubbles clinging to the lures that are released as the lures are worked through the water.”—John Dutton, Owner of Chuck'n for Bass website

“Strike On! Lures makes an incredible series of lures that use rabbit hair as skirt material. These are the only freshwater lures in the industry that use hair for skirts. The first time I fished the lures I was amazed with the action of lures in the water. The hair just comes to life with a tantalizing action. The rabbit hair ebbs and flows constantly causing intense strikes from fish. I am amazed with the action and have never seen anything like it in a freshwater application. The buzz bait has look like no other. It has double tail trailers that move from side to side giving this lure a look that is totally unique to its kind. The hits from fish on the buzzbait have been intense and I have caught some of my biggest bass ever with this lure.”—Ed Harp, Tournament Fishermen and Writer, Ohio

“I met the Strike On! Lure guys at a sportshow in Indianapolis. They approached me and gave me a Hammerin' Hare Jig to fish. I was amazed with what I saw when I cast the jig into the lake behind my house. The rabbit hair came alive in the water fanning out like no other material that I had ever seen. The lure seemed to have a life of its own as the hair opened and began pulsating. The rabbit hair moves constantly creating a lifelike action unlike anything available on any other freshwater lure available on the market. The double tail rabbit hair trailers work great as scent pads as scent can be applied to the hide portion of the tails. The hide soaks in the scent and holds the smell for long periods of time.”—Donnelle Bruno, Tournament Fishermen (B.A.S.S.), Indiana

“I fished the Hammerin' Hare lures for the first time in May of 2001 at a writer's conference on Kentucky Lake. I have to say that I was astonished the first time I saw these lures in the water. They just came alive with action unlike anything I have ever seen before. The rabbit hair has a movement and action creating the most lifelike lure I have ever seen. The rabbit hair moves by itself in the waters current. There is no doubt in my mind that fish think these lures are alive and represent food. These are great lures that catch fish.”—Andy Tyler, Guide and Weekend Professional (Tennessee)

From the August 2001 (Volume 31, No. 8) issue of Bass Times magazine:

Rabbits and Gambling Men

The 44th annual International Sportfishing Expo returned to Las Vegas last month after a brief hiatus, and everyone in attendance was asking the same question: What's up Doc?

In a word lots. For a change.

Despite lagging attendance and an apparent lack of enthusiasm in recent years, the 2001 ICAST Show appeared to awaken from its slumber under the leadership of Norville Prosser, Mike Nussman and others with the American Sportfishing Association. And, in turn, fishing manufacturers responded with some truly exciting product introductions which we'll begin seeing in the coming months.

Among the new exhibitors who set up shop near the gambling dens of Glitter Gulch was a company called Strike On! Lures, a small manufacturer head-quartered in the Colorado mountain community of Edwards, just up the road from Leadville, where at one time in history, the question, “What's up Doc?” might not have been a wise one in the local saloons. A former dentist-turned-gambler by the name of Holliday, fresh off an altercation with some cowboys down in Tombstone, might have taken offense and sent a bullet flying over your head.

But the only thing running scared around Edwards these days are the rabbits.

Elmer Fudd might have given Bugs Bunny a better run for his money had he known about the fish catching qualities of “wabbit” hide.

The Hammerin' Hare Series of artificial lures introduced by Strike On! Lures at last months ICAST Show look flat-out scary. And if they work as good as they look, we might have to cancel Easter next year.

If I had to access the potential of all the new lures I saw in Las Vegas, these would rate high on a short list of the ones I'm most looking forward to fishing.

As the name implies, the Hammerin' Hare Series is a line of lures garbed entirely with rabbit hide and hair.

Using natural fibers from the animal kingdom to create fishing lures is nothing new, of course. Fly fishermen have been using feather and fur since the discovery of bamboo and neoprene waders.

Avid bass fishermen have not totally ignored natural animal fibers, though. Some of the best smallmouth jigs I've ever thrown were trimmed with animal hair. And let's not forget all those Mepps inline spinners many of us grew up fishing. But lures made primarily from natural fibers have largely been the exclusive territory of hard core trout fishermen, those squinty eyed folks who spend their waking hours bent over a vise with No. 16's, feather, fur and thread.

So the origin of Hammerin' Hare should come as no surprise.

“I've been tying my own flies for flyfishing for the past 20 years and have often used small quantities of rabbit hair in many of my patterns,” explained Dan Bryant, who along with his brother Dave, and friend, Mark Walker, is the brains behind Strike On! Lures.

“I then started tying large jigs using rabbit hair for lake trout, and I was amazed with the action of the rabbit hair and was convinced that this material would have an awesome application (for bass and other warm-water species). So my brother and I put our concept through rigorous testing until we finally arrived with the Hammerin' Hare Series.”

The Hammerin' Hare Series features an impressive selection of spinnerbaits, buzzbaits and jigs designed exclusively for largemouth, smallmouth, crappie, musky, pike and walleye. And those high-country folks have done their research well, based on the variety of colors available and standard features built into these new lures.

The company's spinnerbaits feature laser-sharpened Mustad hooks, high-quality ball bearing swivels and even a model constructed of a titanium frame—all at a rather refreshing price for hand-crafted lures. Suggested retail for the titanium frame spinnerbait, for example, is under $6.50.

But it's the hide and fur that make these lures unique.

I had the brief opportunity to view the “Hare” jigs and spinnerbaits in the water, and their action is amazing. The skirts and trailers appear to breathe, responding to even the slightest movement from the angler. In addition to impressive lifelike action, there's yet another benefit to using rabbit hair and hide. The hair absorbs air bubbles that are released as the lure descends in the water column. And the hide readily absorbs fish scents and attractants, unlike the synthetic fibers used on most jigs and spinnerbaits today.

Taking on the likes of PRADCO, Stanley, Terminator, Strike King and others is a daunting task for any upstart lure company. From manufacturing to material acquisition, from market penetration to distribution networks, “its all a little overwhelming,” admitted company cofounder Mark Walker.

“The biggest thing is trying to digest everything all at once. But we've had lots of interest and we're hopeful this is all going to work for us.”

So, the question bears repeating: “What's up, Doc?”

Well, you might want to check out the Hammerin' Hare Lures in the not-too-distant-future. The only downside is that rabbits could become the next endangered species we'll have to worry about.—Matt Vincent, Editor of Bass Times.

### Additional Embodiments

The hair may be attached to the hook or framework of the lure in various ways, such as by tying and then gluing, by methods known to those skilled in the art. The hair may be attached in several portions and in several different lengths. The skirts of the lures are comprised of real rabbit hair in a handcrafted assembly. The lures may have a double or single rabbit hair tail. The lures may be made with or without a weedguard for the hook. The rabbit hair absorbs scents favored by fishermen in larger quantities than rubber or silicone skirts. The lures may be made in a wide variety of colors, weights, sizes and blade designs. Weights may vary over the range of at least 1/16 to 2 ounces. The buzzbait has a novel double blade design. The two blades spin in opposite directions during the retrieve, creating maximum splash and commotion on the water surface.

### Alternative Embodiments

Many alternative embodiment of the invention are possible including different colors of rabbit hair (resulting from dying), different sizes of the rabbit hair portions of the lures, single or double rabbit hair tails on the lures, different sizes and weights of the hook or head, different points of attachment of the rabbit hair to the hook, different types of weed guards, and a number of variations on the willow leaf and Colorado blade assembly, the double willow leaf spinner bait assembly, the power buzz bait assembly, and the double blade power buzz bait assembly. With respect to the latter assemblies, the rabbit hair may be attached at different distances from these assemblies. The rabbit hair may be attached to the body of the lure by many different methods besides tying and gluing. The overall size of the lure may vary widely depending on the size of the fish desired to be caught.

### Conclusions, Ramifications and Scope

A number of changes are possible to the structure, color and weight, etc. as described above, while still remaining within the scope and spirit of the invention.

The specifics about the form of the invention described in this Application are not intended to be limiting in scope. The scope of the invention is to be determined by the claims, and their legal equivalents, not the examples given above.

We claim:

1. A fishing lure comprising a hook or framework, and one or more pieces of rabbit hair of sufficient size to noticeably move when saturated with water, whereby fish are attracted to the movement and bite the lure.

2. A fishing lure comprising a hook or framework, and one or more pieces of rabbit skin, with attached rabbit hair, of sufficient size to noticeably move when saturated with water, whereby fish are attracted to the movement and bite the lure.

3. The fishing lure of claim 1, wherein said one or more pieces of a rabbit hair comprise one elongated piece of rabbit hair adapted to extend from the hook or framework, and adapted to move and flex when saturated with water.

4. The fishing lure of claim 2, wherein said one or more pieces of a rabbit skin comprise one elongated piece of rabbit skin adapted to extend from the hook or framework, and adapted to move and flex when saturated with water.

5. The fishing lure of claim 1, wherein said one or more pieces of rabbit hair comprise an elongated piece of rabbit hair adapted to extend from the hook or framework and adapted to move and flex when saturated with water, and a smaller piece of rabbit hair positioned to partly or totally cover the hook or framework of the lure.

6. The fishing lure of claim 2, wherein said one or more pieces of rabbit skin comprise an elongated piece of rabbit skin adapted to extend from the hook or framework, and adapted to move and flex when saturated with water, and a smaller piece of rabbit skin positioned to partly or totally cover the hook or framework of the lure.

7. The fishing lure of claim 1, wherein said one or more pieces of rabbit hair are positioned with respect to said hook or framework so as to resemble the shape of one or more food sources or objects which attract the attention of fish.

8. The fishing lure of claim 2, wherein said one or more pieces of rabbit skin are positioned with respect to said hook or framework so as to resemble the shape of one or more food sources or objects which attract the attention of fish.

9. The fishing lure of claim 5, further comprising an additional elongated piece of rabbit hair.

10. The fishing lure of claim 6, further comprising an additional elongated piece of rabbit skin.

11. The fishing lure of claim 1, wherein the rabbit hair is colored with a color attractive to the fish desired to be caught.

12. The fishing lure of claim 2, wherein the rabbit hair and skin are colored with a color attractive to the fish desired to be caught.

13. The fishing lure of claim 3, wherein the rabbit hair is colored with a color attractive to the fish desired to be caught.

14. The fishing lure of claim 4, wherein the rabbit hair and skin are colored with a color attractive to the fish desired to be caught.

15. The fishing lure of claim 5, wherein the rabbit hair is colored with a color attractive to the fish desired to be caught.

16. The fishing lure of claim 6, wherein the rabbit hair and skin are colored with a color attractive to the fish desired to be caught.

17. The fishing lure of claim 7, wherein the rabbit hair is colored with a color attractive to the fish desired to be caught.

18. The fishing lure of claim 8, wherein the rabbit hair and skin are colored with a color attractive to the fish desired to be caught.

19. The fishing lure of claim 1, further comprising a scent attractive to fish and impregnated in the rabbit hair.

20. The fishing lure of claim 2, further comprising a scent attractive to fish and impregnated in the rabbit hair.

21. The fishing lure of claim 2, further comprising a fiber bundle weed guard.

22. The fishing lure of claim 2, further comprising an assembly selected from the group consisting of:
(a) a willow leaf and Colorado blade assembly,
(b) a double willow leaf spinner bait assembly,
(c) a power buzz bait assembly, and
(d) a double blade power buzz bait assembly.

23. The process of making a fishing lure comprising a hook or framework, comprising the steps of
(a) cutting rabbit skin with attached hair, in one or more pieces of size sufficient to id cause the rabbit skin to noticeably move when saturated with water, and
(b) attaching one or more pieces of the rabbit skin to the hook or framework.

24. The product made by the process of claim 23.
